(19) United States
(12) Patent Application Publication
(10) Pub. No.: US 2023/0335759 A1
(43) Pub. Date: Oct. 19, 2023

(54) SUPPORTING BODY AND METHOD FOR PRODUCING SUPPORTING BODY

(71) Applicants: TOYOTA BOSHOKU KABUSHIKI KAISHA, Aichi (JP); KEIO UNIVERSITY, Tokyo (JP)

(72) Inventors: Akira OHNUMA, Aichi (JP); Tomotaka SAITO, Aichi (JP); Atsushi NAKAJIMA, Kanagawa (JP)

(73) Assignees: TOYOTA BOSHOKU KABUSHIKI KAISHA, Aichi (JP); KEIO UNIVERSITY, Tokyo (JP)

(21) Appl. No.: 18/130,608

(22) Filed: Apr. 4, 2023

(30) Foreign Application Priority Data
Apr. 18, 2022 (JP) 2022-068188

(51) Int. Cl. H01M 4/92; H01M 4/88

(52) U.S. Cl. CPC H01M 4/925; H01M 4/921; H01M 4/88

(57) ABSTRACT

A supporting body includes a cluster of an alloy containing Pt and Co, and a support on which the cluster is supported. An amount of Pt supported is 1×10⁻¹⁴ ng/cm² or more and 1×10⁵ ng/cm² or less.

### BACKGROUND OF THE INVENTION

### (1) Field of the Invention

The present disclosure relates to a supporting body and a method for producing the supporting body. The present application is based on Japanese Patent Application No. 2022-68188 filed on Apr. 18, 2022 and claims the benefit of the priority thereof, the entire content of which is incorporated herein by reference.

### (2) Description of Related Art

Platinum (Pt) is widely used as an electrode catalyst for fuel cells. However, Pt is a very expensive noble metal. In addition, a reserve of Pt is insufficient. Therefore, in order to realize cost reduction of fuel cells and spread of fuel cells, it is important to improve catalytic activity and reduce an amount of Pt to be used.

So far, a technique has been disclosed in which Pt nano-fine particles or the like contained in a predetermined dendrimer (dendritic polymer) are supported on a porous carbon material, and this Pt-supported carbon material is used as a catalyst (see JP 2013-159588 A).

### SUMMARY OF THE INVENTION

However, the supporting body obtained by the above technique is industrially disadvantageous in the following three points.

That is,

(1) Various reagents (including organic solvents) are required for the synthesis of dendrimers, which is industrially disadvantageous.

(2) In the first place, mass production techniques of dendrimers have not been established yet.

(3) A step of combining the synthesized Pt particles and the carbon material is separately required, which is complicated.

The present disclosure has been made in view of the above circumstances, and an object thereof is to provide a supporting body in which a cluster is supported on a support, and which can be industrially mass-produced. The present invention is expected to be applied in a wide range of fields.

The present disclosure can be realized as the following forms.

[1] A supporting body including: a cluster of an alloy containing Pt and Co; and a support on which the cluster is supported,
wherein an amount of Pt supported is 1×10⁻¹⁴ ng/cm² or more and 1×10⁵ ng/cm² or less.

[2] The supporting body according to [1], wherein the support is made of a conductive material.

[3] The supporting body according to [1], wherein a composition of the cluster is one or more selected from the group consisting of Pt₄Co₂, Pt₅Co, Pt₆Co₂, Pt₇Co₂, and Pt₈Co.

[4] The supporting body according to [2], wherein a composition of the cluster is one or more selected from the group consisting of Pt₄Co₂, Pt₅Co, Pt₆Co₂, Pt₇Co₂, and Pt₈Co.

[5] A production method for producing the supporting body according to [1], the method including:
a generation step of generating the cluster; and
a supporting step of landing and supporting the cluster on the support.

[6] The production method according to [5], which further includes a sorting step of sorting out a specific mass cluster having a mass within a specific range from among the clusters,
wherein, in the supporting step, the specific mass cluster is landed on the support.

The supporting body of the present disclosure can be relatively easily produced, and thus can be industrially mass-produced.

The method for producing the supporting body of the present disclosure is easier than conventional methods, and is suitable for industrial mass production.

### BRIEF DESCRIPTION OF THE DRAWINGS

In the present disclosure, the present invention will be further illustrated in the following detailed description, with reference to a plurality of figures referred to herein, by way of non-limiting examples of typical embodiments according to the invention.

FIG. 1 is a conceptual diagram illustrating an example of an apparatus for carrying out a method for producing a cluster supporting body.

### DETAILED DESCRIPTION OF PREFERRED EMBODIMENTS

The particulars described herein are given by way of example and for the purpose of illustrative discussion of the embodiments of the present invention, and are presented for the purpose of providing what is believed to be the description from which the principles and conceptual features of the present invention can be most effectively and readily understood. In this regard, no attempt is made to show structural details of the present invention in more detail than is necessary for the fundamental understanding of the present invention, and the description is taken with the drawings making apparent to those skilled in the art how several forms of the present invention may be embodied in practice.

Hereinafter, the present disclosure will be described in detail. In addition, in the present specification, a phrase about a numerical range using the word “to” includes a lower limit value and an upper limit value unless otherwise specified. For example, the phrase “10 to 20” includes both the lower limit value “10” and the upper limit value “20”. That is, the phrase “10 to 20” has the same meaning as “10 or more and 20 or less”.

In the present specification, the upper and lower limit values of each numerical range can be arbitrarily combined.

### 1. Supporting Body

The supporting body includes: a cluster of an alloy containing Pt and Co; and a support on which the cluster is supported. An amount of Pt supported is 1×10⁻¹⁴ ng/cm² or more and 1×10⁵ ng/cm² or less.

### (1) Element Forming Cluster

The cluster is made of an alloy containing Pt (platinum) and Co (cobalt) from the viewpoint of practicality. The alloy may contain an element capable of forming the conductive material as other elements than Pt and Co. As the other elements, for example, one or more selected from the group consisting of Au (gold), Ag (silver), Pd (palladium), Ni (nickel), Si (silicon), Ge (germanium), Sn (tin), In (indium), Cd (cadmium), Zn (zinc), W (tungsten), Ta (tantalum), Cu (copper), Ru (ruthenium), Ir (iridium), Cr (chromium), Fe (iron), V (vanadium), Mn (manganese), Y (yttrium), Tc (technetium), Ga (gallium), Nb (niobium), Mo (molybdenum), Zr (zirconium), Rh (rhodium), Os (osmium), Re (rhenium), Al (aluminum), and Ti (titanium) can be suitably exemplified.

### (2) Composition of Cluster

A composition of the cluster is not particularly limited as long as it contains Pt (platinum) and Co (cobalt). The composition of the cluster is preferably one or more selected from the group consisting of Pt₄Co₂, Pt₅Co, Pt₆Co₂, Pt₇Co₂, and Pt₈Co from the viewpoint of high mass activity.

The cluster in the present disclosure is a nanocluster or a sub-nanocluster. A form of the cluster is not particularly limited, but is, for example, a form in which Pt atoms and Co atoms are aggregated in a ratio corresponding to the above composition.

### (3) Amount of Pt (Platinum) Supported

An amount of Pt supported is 1×10⁻¹⁴ ng/cm² or more and 1×10⁵ ng/cm² or less. When the supported amount is within this range, the activity tends to be high when the supporting body is used as a catalyst.

The reason why the mass activity is high when the amount of Pt (platinum) supported is 1×10⁻¹⁴ ng/cm² or more and 1×10⁵ ng/cm² or less is presumed to be attributed to an increase in specific surface area due to the reduction in size of the cluster. The “mass activity” means mass activity (oxygen reduction current density per g of Pt) for an oxygen reduction reaction (ORR) (the same applies hereinafter).

### (4) Mass Activity

The mass activity of the supporting body having the cluster of the alloy supported on the support is preferably more than 300 A/g, more preferably 400 A/g or more, further preferably 500 A/g or more, further preferably 600 A/g or more, and further preferably 700 A/g or more. An upper limit value of the mass activity is usually 2×10⁴ A/g.

When the mass activity is within this range, the supporting body is useful as an electrode catalyst such as a fuel electrode.

### (5) Support

The support is not particularly limited. Examples of the support include carbon, titanium oxide, bismuth tellurium, bismuth selenium, aluminum, constantan, gold, silver, copper, brass, platinum, nichrome, iron, titanium, tungsten, tungsten oxide, indium tin oxide, strontium titanate, molybdenum, zinc, nickel, tin, lead, silicon, silicon carbide, stainless steel, magnesium, cobalt, lithium, chromium, manganin, polyaniline, poly(3,4-ethylenedioxythiophene)-poly(styrene sulfonate) [PEDOT/PSS], polyacetylene, polythiophene, polypyrrole, polyphenylenevinylene, polythienylenevinylene, and ionic liquids. In addition, among these examples, those that can be doped with other elements include those doped with other elements.

### 2. Method for Producing Supporting Body

A method for producing the supporting body is not particularly limited. Here, a suitable method for producing the supporting body will be described.

The production method for producing the supporting body includes: a generation step of generating the cluster; and a supporting step of landing and supporting the cluster on the support.

### (1) Generation Step

In the generation step, generation method that generates (produces) a cluster is not particularly limited, and a wide range of methods can be employed. For example, a magnetron sputtering method, an ion sputtering method, an ion beam sputtering method, a laser vaporization method, or the like can be used. Among them, the magnetron sputtering method is suitably used from the viewpoint of an amount of ions and stability thereof.

The number of atoms of the cluster generated in the generation step is preferably 2 or more and 100 or less, and more preferably 3 or more and 80 or less, from the viewpoint of an efficient catalytic reaction.

Elements forming cluster ions contain at least Pt (platinum) and Co (cobalt). Elements capable of forming the conductive material may be contained as other elements forming the cluster ions. The other elements preferably have target conductivity in the DC magnetron sputtering method, and, for example, one or more selected from the group consisting of Au (gold), Ag (silver), Pd (palladium), Ni (nickel), Si (silicon), Ge (germanium), Sn (tin), In (indium), Cd (cadmium), Zn (zinc), W (tungsten), Ta (tantalum), Cu (copper), Ru (ruthenium), Ir (iridium), Cr (chromium), Fe (iron), V (vanadium), Mn (manganese), Y (yttrium), Tc (technetium), Ga (gallium), Nb (niobium), Mo (molybdenum), Zr (zirconium), Rh (rhodium), Os (osmium), Re (rhenium), Al (aluminum), and Ti (titanium) can be suitably exemplified. In the laser vaporization method and the high frequency magnetron sputtering method, it is possible to generate the cluster ions regardless of the presence or absence of the target conductivity.

### (2) Supporting Step

In the supporting step, the cluster is landed and supported on the support.

For the support which supports the cluster, the description of “1. (5) Support” given above can be applied as it is.

So-called soft landing is adopted as the landing of the cluster on the support. That is, a collision energy is preferably 1 eV/atom or less. This soft landing of the cluster makes it possible to suppress the cluster from being broken.

### (3) Other Steps

The method for producing the supporting body can include a sorting step of sorting out a specific mass cluster having a mass within a specific range from among the clusters. When the method includes the sorting step, the specific mass cluster is landed on the support. By this sorting step, the specific mass cluster is supported on the supporting body, and a utility value of the supporting body is improved.

The sorting step is not particularly limited. The sorting step preferably uses an ion deflector and a quadrupole mass spectrograph. Ions in a specific charge state can be sorted out using the ion deflector, and, further, clusters of a specific size can be sorted out using the quadrupole mass spectrograph.

### (4) Example of Apparatus for Carrying Out Method for Producing Cluster Supporting Body

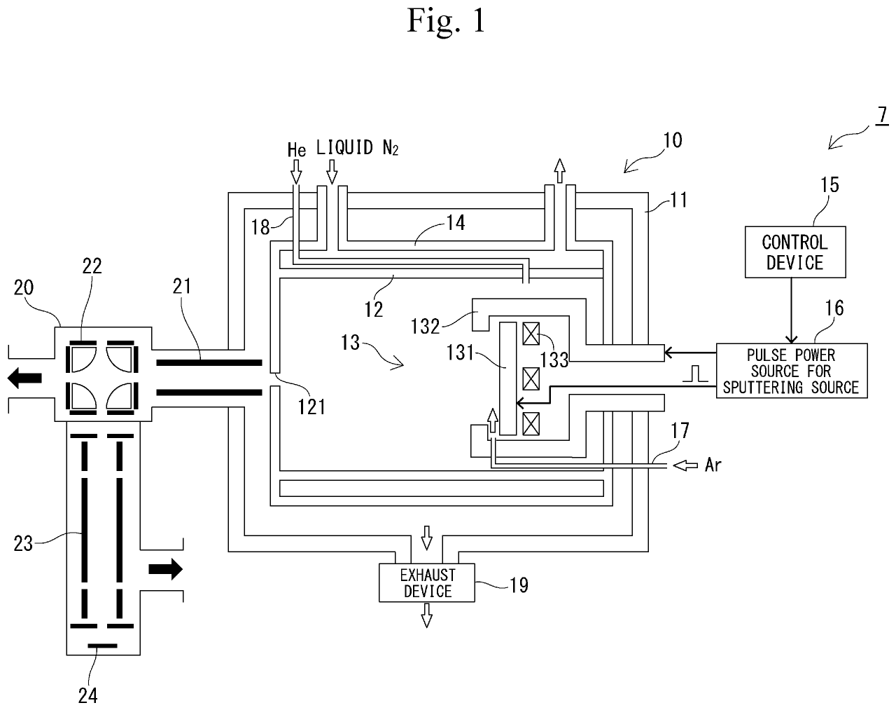

Here, an example of a cluster supporting body producing apparatus 7 for carrying out the production method will be described (FIG. 1).

The cluster supporting body producing apparatus 7 includes a cluster generation device 10. The cluster generation device 10 includes a chamber 11 to be evacuated, a cluster growth cell 12 installed in the chamber 11, and a sputtering source 13 (magnetron sputtering source) installed in the cluster growth cell 12. The cluster growth cell 12 is surrounded by a liquid nitrogen jacket 14, and liquid nitrogen (N₂) flows through the liquid nitrogen jacket 14. The cluster generation device 10 further includes a control device 15 and a pulse power source 16 for the sputtering source as components of the control system.

The cluster generation device 10 includes a first inert gas supply pipe 17 and a second inert gas supply pipe 18. The first inert gas supply pipe 17 supplies a first inert gas (for example, argon gas (Ar)) for generating plasma to the sputtering source 13. The second inert gas supply pipe 18 supplies a second inert gas (for example, helium gas (He)) for cooling and aggregating metal atoms and metal ions generated from the sputtering source 13 and growing the metal atoms and metal ions as clusters, into the cluster growth cell 12. A main part of the second inert gas supply pipe 18 is housed in the liquid nitrogen jacket 14, and spirally goes around within the liquid nitrogen jacket 14, and an end thereof protrudes to an inside of the cluster growth cell 12.

In this way, the second inert gas such as helium cooled by liquid nitrogen can be introduced into the cluster growth cell 12. An internal pressure of the cluster growth cell 12 is maintained at about 10 to 40 Pa. Note that devices such as a pressure gauge provided for pressure control in the cluster growth cell 12 and a mass flow controller provided in the gas supply system are not illustrated.

The cluster generation device 10 further includes an exhaust device 19 including a turbo molecular pump or the like, and the inside of the chamber 11 is exhausted to a predetermined degree of vacuum (for example, 10-1 to 10-4 Pa) by the exhaust device 19.

The sputtering source 13 is composed of a target 131, an anode 132, and a magnet unit 133, and the target 131 is connected to the pulse power source 16 for the sputtering source as a cathode. The Ar gas is supplied into the cluster growth cell 12 from the first inert gas supply pipe 17, and pulsed power is supplied from the pulse power source 16 for the sputtering source, whereby glow discharge occurs between the target 131 and the anode 132. That is, a high voltage is applied in a pulsed manner between the target 131 and the anode 132, whereby glow discharge occurs between the target 131 and the anode 132. In addition, a magnetic field is applied to the vicinity of a surface of the target 131 by the magnet unit 133, so that the cluster generation device 10 of the present embodiment can perform magnetron sputtering and generate further stronger glow discharge.

A tip of the first inert gas supply pipe 17 is configured to inject the first inert gas from one or more places between the target 131 and the anode 132 of the sputtering source 13. However, the present invention is not limited to such a configuration, and any configuration can be adopted as long as the first inert gas can be supplied toward the target 131.

The sputtering source 13 is accommodated within the cluster growth cell 12 so as to be movable in a pipe axis direction. Thus, an extension distance of a cluster growth region in the pipe axis direction is defined. Note that the extension distance in the pipe axis direction means a growth region length, that is, a distance from the surface of the target 131 to a beam outlet 121.

In order to generate the clusters, the first inert gas is supplied to the sputtering source 13 in a state where the second inert gas cooled to a liquid nitrogen temperature is introduced into the cluster growth cell 12, and pulse power is supplied from the pulse power source 16 for the sputtering source. When the pulse power is supplied, sputtered particles such as neutral atoms and ions derived from the target 131 are released as a group from the target 131 into the second inert gas.

This group is released at intervals of a repetition frequency of the pulse power applied to the sputtering source 13, and moves along the flow of the second inert gas. At this time, the sputtered particles such as neutral atoms and ions forming the group are bonded to each other in the second inert gas to generate clusters of various sizes. The generated clusters pass through the beam outlet 121 of the cluster growth cell 12, and then enter an ion detection device or the like at the subsequent stage.

The ion detection device 20 has an ion guide electrode 21 on an outer side in the vicinity of the beam outlet 121 of the cluster growth cell 12, and thus guides the cluster ions released from the beam outlet 121 of the cluster growth cell 12. As illustrated in FIG. 1, the ion detection device 20 includes a quadrupole ion deflector 22 provided on a beam outlet side of the ion guide electrode 21. The quadrupole ion deflector 22 deflects and extracts only either of positive ions and negative ions in the clusters.

The ion detection device 20 includes a quadrupole mass spectrometer 23 that analyzes masses of the extracted clusters, extracts only a cluster having a specific mass, and measures an amount of the cluster generated by an ion detector 24 (picoampere meter) capable of applying a bias. For example, a current of 100 pA measured by the ion detector 24 corresponds to 0.6×10⁹ clusters/second (=1 fmol/second) as the cluster amount. The support can be placed on the ion detector 24 to deposit only clusters having a specific mass on the support.

### 3. Effect of the Present Embodiment

The supporting body of the present embodiment can be relatively easily produced, and thus can be industrially mass-produced.

The method for producing the supporting body of the present embodiment is easier than conventional methods using a dendrimer, and is suitable for industrial mass production.

### Examples

Hereinafter, the present disclosure will be described more specifically by way of Examples.

### 1. Preparation and Evaluation Method of Cluster Supporting Body

A cluster supporting body was prepared using the cluster supporting body producing apparatus 7 illustrated in FIG. 1.

Specifically, clusters of alloys containing Pt and Co were generated by the magnetron sputtering method using the cluster generation device 10. The apparatus specifications and experimental parameters are as follows.
Sputtering source: manufactured by Angstrom Sciences ONYX-2
Pulse power source: manufactured by Zpulser AXIA-150
Target: Pt—Co alloy (diameter: 2 inches, purity: 99.9% or more)
Ar gas flow rate: 40-200 sccm
He gas flow rate: 60-400 sccm
Internal pressure of growth cell: 10-40 Pa
Internal diameter of growth cell: 110 mm
Length of growth region: 190-290 mm
Diameter of beam outlet: 12 mm

For the clusters of the alloys, a specific charge state was sorted out by the quadrupole ion deflector 22, and their sizes were sorted by the quadrupole mass spectrometer 23 (quadrupole mass spectrograph). Thereafter, alloy cluster ions were caused to land on an electrode of glassy carbon (glass-like carbon) (corresponding to the support of the present invention). A diameter of the electrode was 5 mm. The electrode of glassy carbon was polished using an alumina suspension (particle size: 0.05 μm) on a buff, cleaned by irradiation with ultrasonic waves in ultrapure water after polishing, and quickly introduced into a vacuum chamber to support the clusters of the alloys thereon. The supported amount was calculated from the current value measured by the ion detection device 20. The mass activities (catalytic activities) of the clusters in the cluster supporting body were evaluated using a rotating disk electrode (RDE).

### 2. Evaluation Results

Tables 1 and 2 show the results when the clusters of the alloys were supported. The supported amount (ng-Pt/cm²) means an amount of Pt in the alloy supported in the supporting body. Pt₅Co was evaluated with two different supported amounts. The results are shown in Tables 1 and 2, respectively.

From the results in Tables 1 and 2, in any of the compositions, the mass activity was significantly higher than the mass activity of 300 A/g of the standard catalyst (TEC10E50E: manufactured by TANAKA Kikinzoku Kogyo K.K.). This is presumed to be attributed to an increase in specific surface area due to the reduction in size of the cluster. Further, in any of the compositions, the cluster supporting body can be produced by the cluster supporting body producing apparatus 7 using the magnetron sputtering method, and thus can be industrially advantageously mass-produced as compared with the case of using a dendrimer.

TABLE 1

| Cluster | Supported | |
|---|---|---|
| composition | amount (ng-Pt/cm²) | Mass activity (A/g-Pt) |
| Pt₄Co₂ | 221 | 600 |
| Pt₅Co | 211 | 765 |
| Pt₆Co₂ | 234 | 751 |
| Pt₇Co₂ | 166 | 567 |
| Pt₈Co | 208 | 416 |

TABLE 2

| Cluster | Supported | Mass |
|---|---|---|
| composition | amount (ng-Pt/cm²) | activity (A/g-Pt) |
| Pt₅Co | 1208 | 704 |

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the scope of the appended claims, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, which are within the scope of the appended claims.

The present disclosure is not limited to the embodiments described in detail above, and can be modified or changed in various manners within the scope as set forth in the claims of the present disclosure.

The supporting body of the present disclosure can be used in a wide range of applications in a wide range of technical fields. For example, the supporting body as an example of the present disclosure can be suitably used in a fuel cell electrode catalyst, an organic synthesis reaction catalyst, an exhaust gas catalyst, and the like. Since the supporting body of the present disclosure has high catalytic activity, the amount of Pt used can be reduced. Further, it can be mass-produced, and thus has a high cost reducing effect and can be widely spread.

1. A supporting body comprising: a cluster of an alloy containing Pt and Co; and a support on which the cluster is supported,
wherein an amount of Pt supported is 1×10⁻¹⁴ ng/cm² or more and 1×10⁵ ng/cm² or less.

2. The supporting body according to claim 1, wherein the support is made of a conductive material.

3. The supporting body according to claim 1, wherein a composition of the cluster is one or more selected from the group consisting of Pt₄Co₂, Pt₅Co, Pt₆Co₂, Pt₇Co₂, and Pt₈Co.

4. The supporting body according to claim 2, wherein a composition of the cluster is one or more selected from the group consisting of Pt₄Co₂, Pt₅Co, Pt₆Co₂, Pt₇Co₂, and Pt₈Co.

5. A production method for producing the supporting body according to claim 1, the method comprising:
generating a plurality of clusters, wherein each generated cluster of the plurality of clusters is a cluster of an alloy containing Pt and Co; and
landing and supporting at least one cluster of the plurality of clusters on the support.

6. The production method according to claim 5, further comprising:
sorting out a specific mass cluster having a mass within a specific range from among the plurality of clusters,
wherein the at least one cluster of the plurality of clusters that is landed and supported on the support includes the specific mass cluster.
